(19) United States
(12) Patent Application Publication
(10) Pub. No.: US 2009/0219594 A1
(43) Pub. Date: Sep. 3, 2009

(54) HOLOGRAM REPRODUCING DEVICE AND HOLOGRAM REPRODUCING METHOD

(75) Inventors: Shinji MITSUYA, Miyagi-ken (JP); Seiichi OHGOSHI, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/465,297

(22) Filed: May 13, 2009

Related U.S. Application Data
(63) Continuation of application No. PCT/JP2007/072005, filed on Nov. 13, 2007.

(30) Foreign Application Priority Data
Nov. 14, 2006 (JP) 2006-307824

(51) Int. Cl. G03H 1/26

(52) U.S. Cl. 359/22

(57) ABSTRACT

Disclosed is a hologram reproducing device and a hologram reproducing method capable of reading hologram data at a high speed with low power consumption. When a predetermined voltage is applied to some of the signal electrodes and the scanning electrodes arranged in a matrix, a pixel disposed at an intersection of the signal electrode and the scanning electrode is set as a transmission region, and reproduction light emitted from a hologram recording medium passes through a light control member through the transmission region and is then incident on a light receiving unit. Then, hologram data is reproduced. It is possible to switch the reproduction light passing through the light control member only by changing a combination of voltages applied to the signal electrode and the scanning electrode. Therefore, it is possible to improve the read speed of hologram data.

### CROSS REFERENCE TO RELATED APPLICATIONS

This application is a continuation of International Application No. PCT/JP2007/072005, filed on Nov. 13, 2007, which claims benefit of the Japanese Patent Application No. 2006-307824, filed on Nov. 14, 2006, the entire content of both of which are hereby incorporated by reference.

### BACKGROUND

1. Technical Field

The present disclosure relates to a hologram reproducing device and a hologram reproducing method for radiating reference light to reproduce hologram data recorded on a recording medium.

2. Related Art

JP-A-2006-58726 discloses the following structure: during a hologram data reproducing operation, when reproduction reference light is incident on a recording medium having hologram data recorded thereon, the reproduction reference light is diffracted by the interference fringes of the hologram data according to the Bragg condition; reproduction light is emitted; the reproduction light is received by a light receiving element, such as a CCD or CMOS image sensor; and the content of the hologram data included in the reproduction light is read.

In the structure disclosed JP-A-2006-58726, a pinhole filter is provided between the recording medium and the light receiving element. According to the structure disclosed in JP-A-2006-58726, the pinhole filter transmits only the reproduction light of a predetermined hologram, but shields the reproduction light of the other holograms. Therefore, it is possible to read a plurality of hologram data recorded on the recording medium.

The pinhole filter or the light receiving element is mounted to an optical head that can be freely moved. The optical head is moved to the position of each hologram (book position) to read data recorded in each hologram.

In the hologram apparatus according to the related art, in order to reproduce data recorded in the hologram, it is necessary to accurately radiate light having the same wavelength and angle as those of reference light used to write data to a recording medium to a hologram position (book position). Therefore, it is necessary to accurately align the position of the optical system and the position of the recording medium.

However, in the hologram apparatus according to the related art, in order to accurately align the positions, first, the optical head is moved to the hologram position (position adjustment), and then the angle is minutely adjusted. In addition, the optical head is moved in the unit of areas each having a plurality of hologram data, which are called books, recorded therein. Therefore, it is difficult to improve a read speed.

In addition, it is necessary to move the optical head to each hologram. Therefore, it is difficult to reduce power consumption.

### SUMMARY

According to an aspect of the invention, a hologram reproducing device includes: a light emitting unit that emits reference light to a recording medium having a plurality of hologram data recorded thereon; a light receiving unit that receives the reproduction light emitted from the recording medium; and a light control member that is provided between the recording medium and the light receiving unit and can change the size and the position of a light transmission region that transmits light. The light control member is set to an initial state in which it expands the light transmission region and transmits the reproduction light from the plurality of hologram data in a predetermined range of the recording medium to the light receiving unit and a scanning operation state in which it narrows the light transmission region, transmits the reproduction light from one hologram data item in the range to the light receiving unit, and changes the position of the narrowed light transmission region to sequentially switch the reproduction light from the hologram data in the range.

According to the above-mentioned aspect, it is possible to freely change the transmission region that transmits the reproduction light. In this structure, the change in the transmission does not always require the movement of the optical head, unlike the related art. Therefore, it is possible to improve the read speed of hologram data.

In the above-mentioned aspect, the light emitting unit, the light receiving unit, and the light control member may be mounted to an optical head that is moved while facing the recording medium. When the optical head is moved, the range in which the light control member and the recording medium face each other may be moved.

According to the above-mentioned structure, it is possible to reproduce data from a hologram recording medium having a recording region that is too large to reproduce data from the entire recording region using only the light control member.

For example, the light control member may be one of a liquid crystal device, an optical attenuator including a Faraday rotator, and a light control device that changes the amount of light transmitted according to an antiferroelectric-ferroelectric phase transition phenomenon.

According to another aspect of the invention, there is provided a method of reproducing a hologram using a light emitting unit that emits reference light to a recording medium having a plurality of hologram data recorded thereon, a light receiving unit that receives the reproduction light emitted from the recording medium, and a light control member that is provided between the recording medium and the light receiving unit and can change the size and the position of a light transmission region that transmits light. The method includes setting the light control member to an initial state in which the light control member expands the light transmission region and transmits the reproduction light from the plurality of hologram data in a predetermined range of the recording medium to the light receiving unit and a scanning operation state in which the light control member narrows the light transmission region, transmits the reproduction light from one hologram data item in the range to the light receiving unit, and changes the position of the narrowed light transmission region to sequentially switch the reproduction light from the hologram data in the range.

For example, in the method of reproducing a hologram according to the above-mentioned aspect, in the initial state, the incident angle of the reference light on the recording medium may be adjusted on the basis of the amount of light received by the light receiving unit such that the amount of received light becomes the maximum, and the light control member may be changed to the scanning operation state after the initial state.

In the method of reproducing a hologram according to the above-mentioned aspect, after a scanning operation in a predetermined range is completed, the optical head having the light emitting unit, the light receiving unit, and the light control member mounted thereto may be moved to move the range in which the light control member and the recording medium face each other.

In the method of reproducing a hologram according to the above-mentioned aspect, in the scanning operation state, the light control member may be adjusted to adjust the transmission region that transmits reproduction light obtained from one hologram.

According to the above-mentioned aspects of the invention, it is possible to read hologram data recorded at a plurality of book positions of a recording medium without moving the optical head or the recording medium. Therefore, it is possible to improve a read speed during reproduction.

Further, the movement of the optical head may be performed for each specific area. Therefore, it is not necessary to move the optical head to each book position, unlike the related art. As a result, it is possible to reduce the overall power consumption of a hologram reproducing device.

### BRIEF DESCRIPTION OF THE DRAWINGS

FIG. 1 is a conceptual diagram illustrating an initial setting operation performed by a hologram reproducing device according to an embodiment of the invention;

FIG. 2 is a conceptual diagram illustrating the operation of the hologram reproducing device reproducing hologram data from a recording medium after the initial setting operation shown in FIG. 1 is performed;

FIG. 3 is a plan view illustrating the initial setting of a light control member used in the hologram reproducing device;

FIG. 4 is a plan view illustrating a hologram reproducing operation of the light control member used in the hologram reproducing device;

FIG. 5 is a plan view illustrating the hologram reproducing device mounted to an optical head and a hologram recording medium; and

FIG. 6 is a perspective view illustrating the correspondence among the area of the hologram recording medium, pixels of the light control member, and a light receiving unit.

### DESCRIPTION OF EXEMPLARY EMBODIMENTS

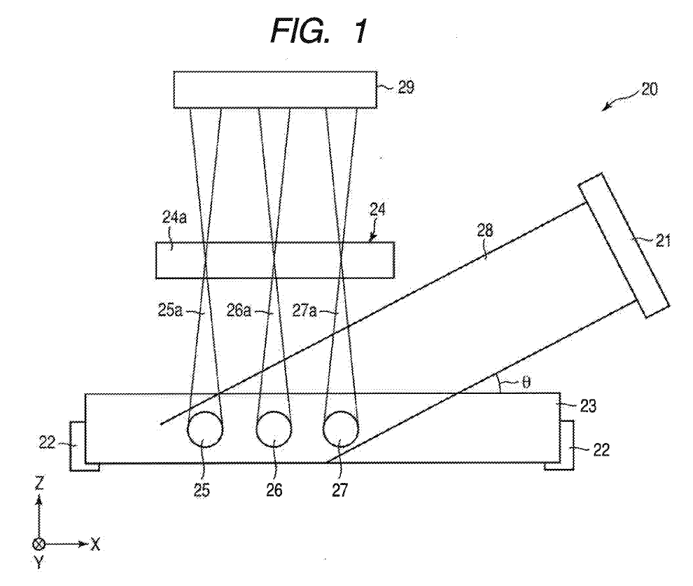

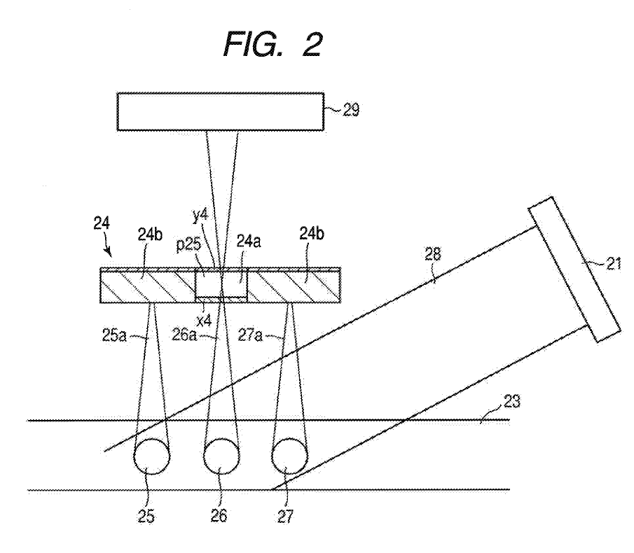

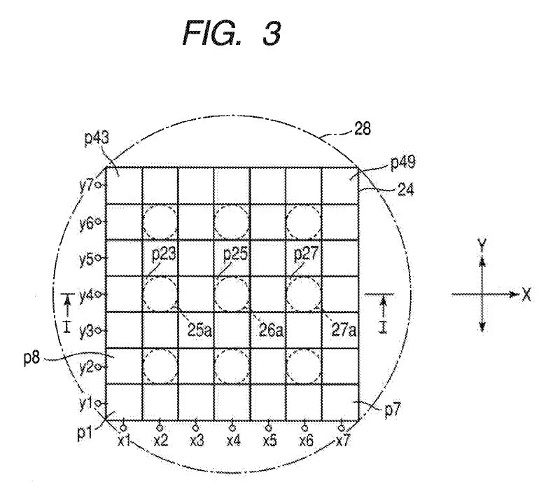

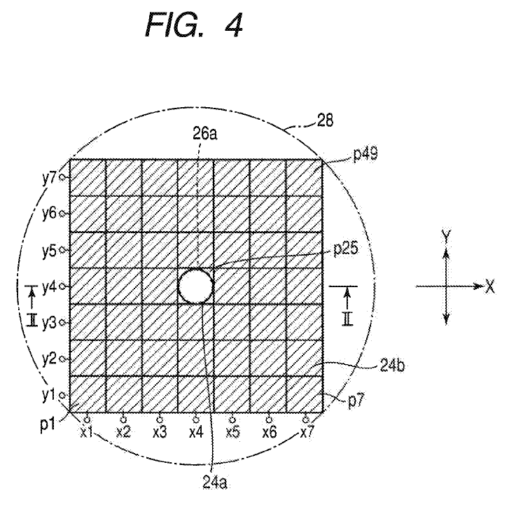

FIG. 1 is a conceptual diagram illustrating an initial setting operation performed by a hologram reproducing device according to an embodiment of the invention. FIG. 2 is a conceptual diagram illustrating the operation of the hologram reproducing device reproducing hologram data from a recording medium after the initial setting operation shown in FIG. 1 is performed. FIG. 3 is a plan view illustrating the initial setting of a light control member used in the hologram reproducing device. FIG. 4 is a plan view illustrating a hologram reproducing operation of the light control member used in the hologram reproducing device. FIG. 1 corresponds to a partial cross-sectional view taken along the line I-I of FIG. 3 in a film thickness direction, as viewed in the direction of an arrow, and FIG. 2 corresponds to a partial cross-sectional view taken along the line II-II of FIG. 4 in the film thickness direction, as viewed in the direction of an arrow.

A hologram reproducing device 20 shown in FIG. 1 includes, for example, a light emitting unit 21, such as a VCSEL array having a plurality of surface-emitting lasers (VCSEL) provided on a substrate, a mounting portion 22 on which a hologram recording medium 23 is mounted, a light receiving unit 29 composed of, for example, a CCD or CMOS image sensor that receives reproduction light components 25a to 27a emitted from the hologram recording medium 23, and a light control member 24 that is provided between the light receiving unit 29 and the mounting portion 22, as main components.

A plurality of hologram data items 25, 26, and 27 are recorded as interference fringes on the hologram recording medium 23 by a hologram recording apparatus (not shown).

A region having a plurality of hologram data items recorded therein is referred to as a ‘book’, and individual hologram data recorded in the book for each angle or each wavelength is referred to as a ‘page’. The hologram data items 25, 26, and 27 shown in FIG. 1 are recorded in different books, and the hologram data items 25, 26, and 27 are recorded according to the incident angle θ and the wavelength of the same reference light. In FIG. 1, the hologram data items 25, 26, and 27 are spaced from each other for clarity of illustration. Actually, the hologram data items 25, 26, and 27 are recorded such that adjacent hologram data items partially overlap with each other. The distance between the centers of the adjacent hologram data items 25, 26, and 27 is about several hundreds of micrometers (μm).

FIG. 1 shows an initial setting operation of adjusting, for example, the incident position, the incident angle θ, and the wavelength of reference light 28.

As shown in FIG. 1, the light emitting unit 21 of the hologram reproducing device 20 emits the reference light 28 to the hologram recording medium 23. For example, a lens array or a mirror actuator (not shown) is provided between the light emitting unit 21 and the mounting portion 22, and the reference light 28 is incident as parallel light on the hologram recording medium 23 at a predetermined incident angle. As shown in FIG. 1, the incident angle of the reference light 28 on the surface of the hologram recording medium 23 is represented by θ.

During the reproduction initial setting operation shown in FIGS. 1 and 3, the entire region of the light control member 24 is set as a transmission region that transmits light in the plate thickness direction.

As the light control member 24, for example, a liquid crystal device may be used in which a plurality of transparent signal electrodes x1 to x7 that are arranged in a line in the lateral direction (an X direction of FIGS. 1 and 3) with a predetermined gap therebetween and extend in the longitudinal direction (a Y direction of FIGS. 1 and 3) and a plurality of transparent scanning electrodes y1 to y7 that are arranged in the longitudinal direction (the Y direction of FIGS. 1 and 3) with a predetermined gap therebetween and extend in the lateral direction (the X direction of FIGS. 1 and 3) are arranged in a matrix so as to be opposite to each other with a liquid crystal layer interposed therebetween (see FIGS. 3 and 4).

Further, in the following description, the liquid crystal device is used as an example of the light control member 24, but the light control member 24 is not limited to the liquid crystal device. For example, any of the following may be used as the light control member 24: an optical attenuator including a Faraday rotator that uses the Faraday effect, which is the rotation of the plane of polarization of light when light passes through a magnetic field parallel to the traveling direction of light, to control the polarized state of light; and a light control element that changes the amount of light transmitted according to an antiferroelectric-ferroelectric phase transition phenomenon.

In the light control member 24, which is the liquid crystal device, pixels are formed at intersections of the signal electrodes x1 to x7 and the scanning electrodes y1 to y7 that are opposite to each other in a plan view. As the number of pixels in the liquid crystal device is increased, the size of a transmission region 24a formed by the light control member 24 during a hologram reproducing operation, which will be described below, can be more minutely controlled. For example, it is possible to reduce relative brightness by increasing a voltage value applied to each of the pixels. In the following description, a plurality of positions where the signal electrodes x1 to x7 and the scanning electrodes y1 to y7 intersect each other are sequentially represented by pixels p1 to p49 (for example, see FIGS. 3 and 4).

As shown in FIGS. 1 and 3, when a predetermined voltage is applied between all the signal electrodes x1 to x7 and all of the scanning electrodes y1 to y7 of the light control member 24, the entire region of the light control member 24 is set as the transmission region 24a. In FIG. 3, a large circle represented by a one-dot chain line indicates a radiation region of the hologram recording medium 23 irradiated with the reference light 28, and a plurality of small circles represented by dotted lines indicate some of a plurality of reproduction light components (hereinafter, referred to as diffracted light) emitted from the hologram recording medium 23.

As shown in FIGS. 2 and 4, when a predetermined voltage is applied between some of the transparent electrodes of the light control member 24, for example, between the signal electrode x4 and the scanning electrode y4, a portion (pixel p25) of the entire region of the light control member 24 in which the signal electrode x4 and the scanning electrode y4 face each other is set as the transmission region 24a, and the other region is set as a non-transmission region 24b. The portion of the entire region may have a predetermined area. As described above, the portion may be formed for each pixel, which is a minimum unit, or it may be formed for each pixel group, which is a set of a plurality of pixels.

As shown in FIG. 1, when the reference light 28 is radiated onto the hologram data items 25, 26, and 27 and the Bragg condition is satisfied, light is diffracted, and reproduction light components 25a, 26a, and 27a are emitted from the hologram recording medium 23 to the light receiving unit 29.

In this case, when the entire region of the light control member 24 is set as the non-transmission region 24b that shields light, the reproduction light components 25a, 26a, and 27a are not incident on the light receiving unit 29. As a result, the light receiving unit 29 cannot receive the reproduction light components 25a, 26a, and 27a.

On the other hand, as shown in FIGS. 1 and 3, when the entire region of the light control member 24 is set as the transmission region 24a that transmits light, the reproduction light components 25a, 26a, and 27a pass through the transmission region 24a to be incident on the light receiving unit 29. As a result, the light receiving unit 29 can receive a plurality of reproduction light components 25a, 26a, and 27a at a time.

As shown in FIGS. 2 and 4, when only a portion (pixel p25) of the entire region of the light control member 24 is set as the transmission region 24a and the other region thereof is set as the non-transmission region 24b, only the reproduction light component 26a corresponding to the portion (pixel p25) of the region can pass through the light control member. That is, in FIG. 4, the pixel p25 set as the transmission region 24a serves as a pinhole that allows the transmission of only the reproduction light component 26a. As a result, the light receiving unit 29 reads the hologram data item 26 included in the reproduction light component 26a.

For example, when a voltage is applied only between the signal electrode x2 and the scanning electrode y4, it is possible to set a pixel p23 corresponding to the hologram data item 25 as the transmission region 24a. When a voltage is applied only between the signal electrode x6 and the scanning electrode y4, it is possible to set a pixel p27 opposite to the hologram data 27 as the transmission region 24a.

That is, it is possible to freely set a pixel as the transmission region 24a formed on the light control member 24 by controlling combinations of the signal electrodes x1 to x7 and the scanning electrodes y1 to y7 supplied with a voltage. Therefore, it is possible to change the position of the transmission region 24a to select reproduction light passing through the light control member 24, and it is possible to freely select hologram data (book) to be read by the light receiving unit 29.

In addition, it is possible to improve the response speed of the liquid crystal device only by changing combinations of the electrodes supplied with a voltage. Therefore, the response speed of the liquid crystal device is higher than that of a mechanical control method according to the related art that uses at least the driving force of a motor to move an optical head. Therefore, it is possible to read hologram data at a higher speed, as compared to the related art.

However, the optical head according to the related art moved by the driving force of the motor is needed. That is, for example, the light control member 24 has a size (area) of about 1 mm×1 mm. In contrast, for example, the hologram recording medium 23 has a size (area) in the range of about 10 mm×10 mm to about several hundreds of millimeters (mm)×several hundreds of millimeters (mm) or more. That is, in general, the area ratio between the light control member 24 and the hologram recording medium 23 is at least 100 or more. In addition, as described above, the distance between adjacent hologram data items is about several hundreds of micrometers (μm).

Therefore, when the light control member 24 is disposed in one area of the hologram recording medium 23, only the book included in the area can be read, but it is difficult to read all the books in the entire area of the hologram recording medium 23.

Therefore, in this embodiment, optical system members of the hologram reproducing device, that is, the light emitting unit 21, the light control member 24, and the light receiving unit 29 are mounted to an optical head 30 that can be moved in the X and Y directions on the X-Y plane, and the light control member 24 is moved a predetermined step to read data from each area.

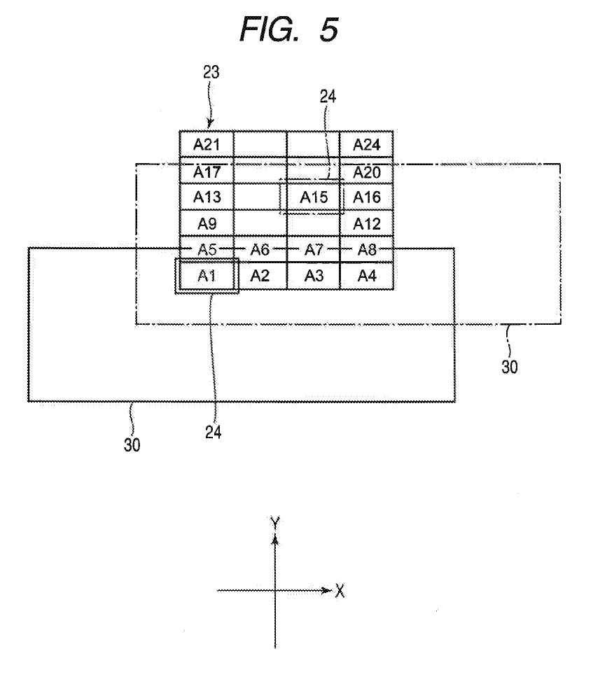

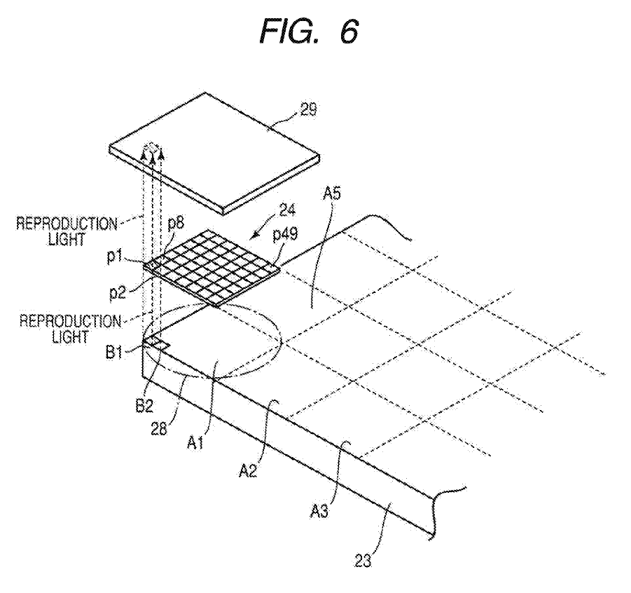

FIG. 5 is a plan view illustrating the optical head having the optical system members of the hologram reproducing device mounted thereon and the hologram recording medium, and FIG. 6 is a perspective view illustrating the correspondence among the area of the hologram recording medium, the pixels of the light control member, and the light receiving unit.

The hologram recording medium 23 is divided into a plurality of areas according to the size of the light control member 24. FIG. 5 shows an example in which the hologram recording medium 23 is logically divided into 24 areas A1 to A24.

When the hologram recording medium 23 is mounted on the mounting portion 22 of the hologram reproducing device 20, a control unit (not shown) controls an XY transport mechanism (not shown) to move the optical head 30 to an initial position and then stop it at that position. As represented by a solid line in FIG. 5, the light control member 24 faces the area A1 at the initial position.

Then, the control unit applies a predetermined voltage to all of the signal electrodes x1 to x7 and the scanning electrodes y1 to y7 such that the entire region of the light control member 24 is set as the transmission region 24a.

Then, the control unit performs an initial setting operation when the optical head 30 stops at the initial position (area A1), that is, an operation of minutely adjusting the incident angle θ of the reference light 28 and setting the incident angle such that the amounts of the reproduction light components 25a to 27a received by the light receiving unit 29 become the maximum. The incident angle θ is adjusted by a mirror actuator (not shown) that is mounted to the optical head.

Then, the control unit changes the state of the transmission region 24a for each pixel or each pixel group.

For example, as shown in FIG. 6, the control unit applies a voltage to only the signal electrode x1 and the scanning electrode y1 to change the pixel p1 corresponding to the electrodes to the transmission region 24a. Then, the control unit reads a book B1 in the area A1 of the hologram recording medium 23 corresponding to the pixel p1.

For example, when there is a little positional deviation between the pixel p1 and reproduction light to be transmitted through the pixel, it is difficult for the reproduction light to pass through the pixel p1, which is an expected transmission region 24a. In this case, it is possible to change a pixel (for example, a pixel p2 or p8) or a pixel group adjacent to the pixel p1 to the transmission region 24a, thereby transmitting the reproduction light. That is, the control unit can select the transmission region 24a that is most suitable to transmit reproduction light to transmit the reproduction light. Alternatively, the size of the transmission region 24a may increase so as to transmit the reproduction light.

Then, the control unit changes the pixel p2 adjacent to the pixel p1 to the transmission region 24a and the other pixels to the non-transmission region 24b. Then, the control unit reads a book B2 in the area A1 corresponding to the pixel p2.

The control unit repeatedly performs the above-mentioned operation to change the pixels or the pixel groups to the transmission region 24a in a predetermined order, thereby reading hologram data included in all the books in the area A1.

One book has a plurality of pages recorded therein by performing angle or frequency multiplexing on hologram data. Therefore, it is possible to read the hologram data of each page by appropriately changing a wavelength or the incident angle θ.

For example, the read of all hologram data from one area may be performed for each book. That is, when each book is read, the mirror actuator is driven to minutely adjust the incident angle θ by a predetermined angle to read all pages from one book, and after the read operation ends, all pages are read from the next adjacent book. Alternatively, the read of all hologram data from one area may be performed for each page. That is, the incident angle θ is fixed to, for example, a first page, and the first pages of all the books are read. Then, the incident angle θ is fixed to a second page, and the second pages of all the books are read.

When the read of hologram data from one area ends, the control unit drives the XY transport mechanism to move the optical head 30 to a position opposite to the next area (for example, the area A2). Then, the control unit can perform the same operation as described above to read all hologram data included in the area A2.

As shown in FIG. 5, for example, when hologram data recorded in the area A15 is read, the control unit drives the XY transport mechanism to move the optical head 30 to a position corresponding to the area A15. Then, the control unit can perform the same operation as described above to read all hologram data recorded in the area A15.

As such, in this embodiment, it is not necessary to move the optical head 30 in the unit of books, unlike the related art, but it is possible to move the optical head in the unit of areas that are larger than the books. Therefore, it is possible to reduce the number of times the optical head is moved. As a result, it is possible to reduce power consumption.

It is possible to read hologram data from one area only by changing a combination of voltages applied between the signal electrodes and the scanning electrodes of the light control member 24 without moving the optical head 30. Therefore, it is possible to reduce the time required to read hologram data.

In addition, during the initial setting operation, since the incident angle is minutely adjusted for each area, it is not necessary to perform the minute adjustment of the incident angle for each book. Therefore, it is possible to improve the read speed of hologram data. In addition, since the optical head is moved a predetermined step for each area, it is not necessary to minutely move the optical head, unlike the related art. Therefore, it is possible to reduce the overall manufacturing costs of a hologram reproducing device.

It should be understood by those skilled in the art that various modifications, combinations, sub-combinations and alterations may occur depending on design requirements and other factors insofar as they are within the scope of the appended claims of the equivalents thereof.

What is claimed is:

1. A hologram reproducing device comprising:
a light emitting unit that emits reference light to a recording medium having a plurality of hologram data recorded thereon;
a light receiving unit that receives the reproduction light emitted from the recording medium; and
a light control member that is provided between the recording medium and the light receiving unit and can change the size and the position of a light transmission region that transmits light,
wherein the light control member is set to an initial state in which it expands the light transmission region and transmits the reproduction light from the plurality of hologram data in a predetermined range of the recording medium to the light receiving unit and a scanning operation state in which it narrows the light transmission region, transmits the reproduction light from one hologram data item in the range to the light receiving unit, and changes the position of the narrowed light transmission region to sequentially switch the reproduction light from the hologram data in the range.

2. The hologram reproducing device according to claim 1,
wherein the light emitting unit, the light receiving unit, and the light control member are mounted to an optical head that is moved while facing the recording medium, and
when the optical head is moved, the range in which the light control member and the recording medium face each other is moved.

3. The hologram reproducing device according to claim 1,
wherein the light control member is one of a liquid crystal device, an optical attenuator including a Faraday rotator, and a light control device that changes the amount of light transmitted according to an antiferroelectric-ferroelectric phase transition phenomenon.

4. A method of reproducing a hologram using a light emitting unit that emits reference light to a recording medium having a plurality of hologram data recorded thereon, a light receiving unit that receives the reproduction light emitted from the recording medium, and a light control member that is provided between the recording medium and the light receiving unit and can change the size and the position of a light transmission region that transmits light, the method comprising:
setting the light control member to an initial state in which the light control member expands the light transmission region and transmits the reproduction light from the plurality of hologram data in a predetermined range of the recording medium to the light receiving unit and a scanning operation state in which the light control member narrows the light transmission region, transmits the reproduction light from one hologram data item in the range to the light receiving unit, and changes the position of the narrowed light transmission region to sequentially switch the reproduction light from the hologram data in the range.

5. The method of reproducing a hologram according to claim 4,
wherein, in the initial state, the incident angle of the reference light on the recording medium is adjusted on the basis of the amount of light received by the light receiving unit such that the amount of received light becomes the maximum, and the light control member is changed to the scanning operation state after the initial state.

6. The method of reproducing a hologram according to claim 4,
wherein, after a scanning operation in a predetermined range is completed, the optical head having the light emitting unit, the light receiving unit, and the light control member mounted thereto is moved to move the range in which the light control member and the recording medium face each other.

7. The method of reproducing a hologram according to claim 4,
wherein, in the scanning operation state, the light control member is adjusted to adjust the transmission region that transmits reproduction light obtained from one hologram.
